(19) United States
(12) Patent Application Publication
(10) Pub. No.: US 2008/0221921 A1
(43) Pub. Date: Sep. 11, 2008

(54) METHOD OF CONDUCTING A CLINICAL TRIAL

(75) Inventors: Charles Steele Love, Santa Barbara, CA (US); Peter Andrew Crosby, Manly (AU)

Correspondence Address: MCCARTER & ENGLISH , LLP STAMFORD OFFICE, FINANCIAL CENTRE , SUITE 304A, 695 EAST MAIN STREET, STAMFORD, CT, 06901-2138, US

(73) Assignee: VENTRASSIST PTY LTD, Chatswood (AU)

(21) Appl. No.: 12/013,613

(22) Filed: Jan. 14, 2008

Related U.S. Application Data
(60) Provisional application No. 60/881,398, filed on Jan. 19, 2007.

(51) Int. Cl. G06Q 50/00

(52) U.S. Cl. 705/2

(57) ABSTRACT

Disclosed are methods of conducting and assessing the outcomes of a randomized controlled clinical trial. The method comprises the steps of: trialing, with respect to a first group of patients as an experimental group, an experimental treatment; and trialing, with respect to a second group of patients as a control group, at least first and second control therapies. The control therapies will have been previously validated or are a known standard of care. This method is described in relation to trialing and assessing implantable medical devices such as left ventricular assist devices (LVAD) but may be used for trialing and assessing other medical devices.

### 1. CROSS-REFERENCE TO RELATED APPLICATIONS

The present application claims the benefit of pending provisional patent application entitled “A Method of Conducting a Clinical Trial” that was filed on Jan. 19, 2007 and assigned Ser. No. 60/881,398. The entire contents of the foregoing provisional patent application are incorporated by reference herein.

### 2. TECHNICAL FIELD

The present invention relates to a method of conducting a clinical trial. Preferably, this invention is for use in the field of implantable medical devices (‘IMD’).

### BACKGROUND OF THE INVENTION

Clinical trials have been used extensively to prove the safety and efficacy of new medical treatments. In particular, clinical trials have been used to demonstrate the safety and efficacy of medical devices and pharmaceuticals in the field. In general, a proposed new therapy requires approval from a regulatory authority before being allowed to be marketed. The regulatory authority in general requires that safety and efficacy be demonstrated. Furthermore, in the case of medical devices, the regulatory authority generally requires that engineering reliability be demonstrated for the proposed new device therapy. Engineering reliability is usually demonstrated by following a significant number of patients with the device over a significant period of time such that enough device failures have accumulated that meaningful statistics can be generated.

The gold standard for clinical trial design is the prospectively randomized controlled clinical trial. In this approach, patients are randomly assigned to control and experimental groups. The control group generally receives a single normal standard treatment and the experimental group receives the newly developed drug, pharmaceutical or medical device. A drug trial is usually “double blinded”, which means neither the patient nor the investigator knows which therapy (the control or the experimental therapy) has been administered. This is impossible for a device trial since it is generally obvious which patients receive a device. It is also generally ethically impossible to provide a non-functioning (or “sham”) device.

The ethical considerations for clinical trials on human subjects dictate that the standard treatment or therapy for the control group has been previously approved by regulatory bodies or has been found to be safe and effective for the particular use, and has been adopted as the standard of care as the best available. Generally, the two different groups are of sufficient size to allow for reliable statistical analysis to be conducted. If the clinical trial is successful and the new therapy is shown to be significantly better than the control therapy, then it seems logical that the new therapy would then become the standard of care.

However, a new therapy usually takes some time to be adopted as the standard of care, even if it has been shown to be significantly superior to the control therapy in a randomized trial. The main reason for this is that the medical community generally requires more than one clinical trial to demonstrate superiority of a new therapy over a standard of care, before adopting the new therapy as a new standard of care.

The problem then arises as to how to conduct a trial on a later new therapy before the first new therapy has been adopted as the standard of care. Ethical considerations might dictate that it would be wrong to use the previous standard of care as the control group, when it is known that a better therapy is available. Thus, the control group should be the best available therapy for the condition, but if the best available therapy has not yet been adopted as the standard of care, it will be impossible to conduct the trial because patients will not be recruited. It is the solution to this problem which is the subject of this invention.

The concept of a prospectively randomized controlled clinical trial is well known in the art. U.S. Pat. No. 5,898,586—Jeatran et al. discloses a clinical trial wherein a pharmaceutical is tested and compared against a placebo. Patients are typically randomized between an experimental group trialing the new drug and a control group testing the placebo, which is in effect no treatment.

Another well known example of a successful and well conducted prospectively randomized controlled clinical trial is the Randomized Evaluation Assistance for the Treatment of Congestive Heart failure (‘REMATCH’) trial. The REMATCH trial is described, in detail, in a scientific paper published in The New England Journal of Medicine on 15 Nov. 2001 by Rose et al. This particular trial evaluated whether mechanical left ventricular assist devices currently approved by the US Food and Drug Administration (‘FDA’) for temporary support of persons awaiting a heart transplant (specifically referring to the “Heartmate” XVE LVAD (‘HMI’) manufactured by the Thoratec Corporation) may be used as an effective alternative therapy for patients who are ineligible for heart transplant. The REMATCH trial compared patients implanted with Left Ventricular Assist Devices (‘LVADs’) with a control group who received Optimal Medical Management (OMM) using including drug therapy, diet and exercise.

The REMATCH trial divided the patients into two groups: the control group which was those receiving OMM; and the experimental group, which was those being implanted with the LVAD which was the subject of the trial.

The REMATCH trial was successful in that it showed the benefit (relative advantage) of LVAD therapy compared to the control group. Therefore, theoretically, all subsequent trials of other LVADs should be conducted where the control group consists of those using LVAD which was the subject of the REMATCH trial, since this has now been shown (through the REMATCH trial) to be the best available therapy.

The conundrum, however, is that the HMI has not been adopted as the standard of care for several reasons. Thus if it is desired to conduct a clinical trial of a new LVAD, it will be impossible to do so in a reasonable time and cost if the HMI is adopted as the required therapy for the control group.

In order to obtain regulatory approval for a proposed new device therapy, it is necessary to demonstrate three things: clinical efficacy, clinical safety, and engineering reliability. Clinical efficacy is generally demonstrated with a prospective randomized clinical trial. Clinical safety requires the collection of adequate data on adverse events and complications, usually in the context of a clinical trial (where data collection can be carefully controlled). Engineering reliability requires the collection of data on field performance of the new device over significant populations of patients for a significant period of time.

A problem with obtaining adequate data to obtain regulatory approval for a proposed new medical device therapy is that the number of patients required to demonstrate clinical efficacy may be significantly smaller than the number of patients necessary to demonstrate clinical safety or engineering reliability. For example, it may be only necessary to conduct a trial on 200 patients to demonstrate statistically significant clinical efficacy, but it may require many more than this, or longer time, to provide adequate clinical safety or statistically significant engineering reliability data. Furthermore, if the clinical efficacy of a proposed new device therapy is greatly superior to the clinical efficacy of the control group, it is likely that the clinical trial will be stopped early by the independent Data and Safety Monitoring Board (DSMB). These factors present both an ethical and a practical problem. The ethical problem is that once a new therapy has demonstrated superiority over a previous therapy, then it is no longer ethical to use the previous therapy (which is now known to be inferior) in the control group. Thus a circumstance might arise where the clinical efficacy has been demonstrated, but the clinical safety and/or engineering reliability has not been adequately demonstrated and can not be demonstrated with the number of patients enrolled in the trial at that time, and therefore there are not enough data to obtain regulatory approval, but it is no longer ethical to obtain additional clinical safety or engineering reliability data in the context of a clinical trial. Implantable medical devices are designed for high reliability, and thus the practical problem is that it may often take significantly longer time to obtain adequate engineering reliability data for the device used in the population in the trial once the trial enrollment has been completed, and thus a regulatory approval might be unnecessarily delayed.

In this specification, “Safety” is defined as the state of being safe, the condition of being protected against physical, social, spiritual, financial, political, emotional, occupational, psychological or other types or consequences of failure, damage, error, accidents, harm or any other event which could be considered not desirable. In the context of a medical device “safety” means that the device provides the therapy as intended with an acceptable level of adverse clinical events.

Generally, “Efficacy” is defined as the ability to produce a desired amount of a desired effect. In a medical context it indicates that the therapeutic effect of a given intervention (e.g. intake of a medicine, an operation, or a public health measure) is acceptable. “Acceptable” in that context refers to a consensus that it is at least as good as other available interventions to which it will have ideally been compared to in a clinical trial. For example, an efficacious vaccine has the ability to prevent or cure a specific illness in an acceptable proportion of exposed individuals. In strict epidemiological language, ‘efficacy’ refers to the impact of an intervention in a clinical trial, differing from ‘effectiveness’ which refers to the impact in real world situations. “Prospective” in this specification is defined as a randomized controlled clinical trial wherein the patients are randomized between the therapies prior to commencement of a particular therapy.

Another trial method or design is described within a paper entitled “Progress versus Precision: Challenges in clinical trial design for left ventricle assist devices” published in Annual of Thoracic Surgery (2006; 82:I140-6) by Parides et al. This paper describes a preferred trial being a relatively small randomized trial, which would preserve the advantages of randomization and also allow for generally shorter enrollment times.

A further clinical trial method is described within the paper entitled “FDA perspective on clinical trial design for cardiovascular devices” published in the Annual of Thoracic Surgery (2006; 82:773-775) by Chen et al. This paper generally describes methods of conducting clinical trials into mechanical circulatory support devices including single arm studies and generally randomized controlled trials.

The present invention aims to or at least address or ameliorate one or more of the disadvantages associated with the above mentioned prior art.

### SUMMARY OF THE INVENTION

According to a first aspect there is provided a method of conducting a randomized controlled clinical trial, the method comprising the steps of:

trialing, with respect to a first group of patients as an experimental group, an experimental treatment; and

trialing, with respect to a second group of patients as a control group, at least first and second control therapies,

wherein said control therapies have been previously validated or are a known standard of care.

Preferably said control therapies have been previously validated in respect of safety, efficacy and effectiveness. Preferably said experimental therapy includes the use of a first medical device. Preferably at least one control therapy includes the use of a pharmaceutical. Preferably at least one control therapy includes the use of a second medical device. Preferably said first medical device is a left ventricular assist device.

According to a second aspect there is provided a method of assessing the results of a randomized controlled clinical trial, the method comprising the step of:

comparing data relating to clinical efficacy, clinical safety and reliability obtained from trialing a therapy with respect to an experimental group with data relating to clinical efficacy, clinical safety and reliability from trialing at least first and second control therapies with respect to a control group,

wherein data from at least the first control therapy is compiled from data obtained from publicly available research material.

Preferably, the randomized clinical trial may also be prospective.

Preferably said first control therapy is comparable to the therapy experienced by the experimental but sufficiently different to the warrant to the conduct of a clinical trial. Preferably said experimental group is being treated with a first medical device. Preferably said first control therapy includes a second medical device. Preferably said second control therapy includes a pharmaceutical therapy.

According to a third aspect there is provided a method of conducting a randomized controlled clinical trial, the method comprising the steps of:

trialing, with respect to a first group of patients as an experimental group, an experimental therapy using a first left ventricle assist device (LVAD); and

trialing, with respect to a second group of patients as a control group, at least first and second control therapies,

wherein said at least first and second control therapies have been previously validated or are a known standard of care and said first control therapy includes the use of a second LVAD.

Preferably, the randomized clinical trial may also be prospective.

Preferably said second control therapy includes a pharmaceutical.

According to a fourth aspect there is provided a method of conducting a prospectively randomized controlled clinical trial comprising the steps of:

comparing data relating to clinical efficacy, clinical safety and reliability from trailing a therapy with respect to an experimental group with data relating to clinical efficacy, clinical safety and reliability from trialing at least first and second control therapies with respect to a control group,

wherein the control group includes data from the at least first and second control therapies and wherein the reliability data from the experimental therapy is pooled with reliability data from clinical experience of the experimental therapy in populations of patients outside the clinical trial.

Additionally or alternatively, the clinical safety data from the experimental therapy is pooled with clinical safety data from clinical experience of the experimental therapy in populations of patients outside the clinical trial.

According to another aspect there is provided a method of assessing the results of a randomized controlled clinical trial of an implantable medical device (IMD), the method comprising the steps of:

determining clinical efficacy of an experimental IMD by comparing experimental IMD data with corresponding data of at least one control therapy;

determining clinical safety of the experimental IMD by conducting an absolute number comparison of experimental IMD results data with corresponding results data of at least one control therapy wherein all patients are participating within said clinical trial or another comparable clinical trial;

determining product reliability of the experimental IMD by comparing an absolute number of failing experimental IMDs with the total number of patients using the experimental therapy; and

assessing the results of the clinical trial by comparing the determined clinical efficiency, clinical safety and product reliability.

Preferably, the sample size to determine clinical safety is larger than clinical efficacy. Preferably, the results of the control therapy to determine clinical safety are derived from pooled data of at least two different clinical trials. Preferably, the sample size to determine product reliability is larger than clinical efficacy and/or clinical safety. Preferably, the results for the control therapy used to determine product reliability are derived from pooled data including patients not participating within any clinical trials. Alternatively, the results for the control therapy used to determine product reliability are derived from pooled data including patients not participating within the clinical trial.

In an embodiment there is provided a method of conducting a randomized controlled clinical trial wherein said clinical trial includes testing: a first group of patients as an experimental group trialing an experimental treatment; and a second group of patients as a control group using at least a first and a second control therapies and wherein said control therapies have been previously validated or are a known standard of care. Preferably, the randomized clinical trial may also be prospective.

In another embodiment there is provided a method of conducting a randomized controlled clinical trial wherein said clinical trial includes comparing data relating to clinical efficacy, clinical safety and reliability from: an experimental group and a control group, characterized in that the control group includes data from at least a first and a second control therapies and wherein at least the first control therapy data is compiled from pooled data obtained from publicly available research material.

In another embodiment there is provided a method of conducting a randomized controlled clinical trial wherein said clinical trial includes testing: first group of patients as an experimental group trialing an experimental treatment using a first LVAD; and second group of patients as a control group trialing at least first and second control therapies and wherein said control therapies have been previously validated or are a known standard of care and said first control therapy includes a second LVAD.

In another embodiment there is provided a method of conducting a prospectively randomized controlled clinical trial wherein said clinical trial includes comparing data relating to clinical efficacy, clinical safety and reliability from: an experimental group and a control group, characterized in that the control group includes data from at least a first and a second control therapies and wherein the reliability data from the experimental therapy is pooled with reliability data from clinical experience of the experimental therapy in populations of patients outside the clinical trial.

In another embodiment there is provided a method of conducting a randomized controlled clinical trial of an IMD, wherein said clinical trial includes testing of clinical efficacy; clinical safety and product reliability of an experimental IMD, wherein clinical efficacy is determined by a ratio comparison experimental IMD compared against at least one control therapy; wherein clinical safety is determined by absolute number comparison of experimental IMD compared the results of at least one control therapy wherein all patients are participating within said clinical trial or another comparable clinical trial; and wherein the product reliability is determined by comparison of the absolute numbers of experimental IMD failing when compared to the overall patients using the experimental therapy.

### BRIEF DESCRIPTION OF THE DRAWINGS

Embodiments of the present invention will now be described with reference to the accompanying drawing wherein:

FIG. 1 depicts a schematic view of a preferred embodiment of the present invention.

### BRIEF DESCRIPTION OF THE PREFERRED EMBODIMENTS

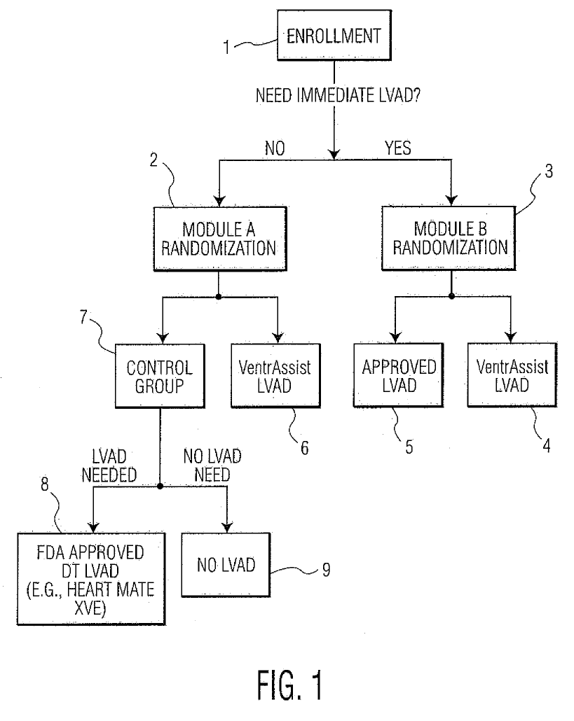

FIG. 1 depicts an example of a method of conducting a randomized clinical trial in a preferred embodiment of the present invention. The clinical trial is for the purpose evaluating the effectiveness of an LVAD comprising an implantable rotary blood pump as described within U.S. Pat. No. 6,227,797—Watterson et al, which is called “VENTRASSIST® LVAD” throughout this specification, where “VENTRASSIST®” is a registered trademark of Ventracor Ltd, a company registered in Australia. The description of this device from the aforementioned US patent is incorporated within this specification. As will be understood, in other embodiments, other medical devices, such as other LVADs, mechanical hearts, right ventricle assist devices (RVADs) and so on could be evaluated.

The trial begins with the selection of a number of patients meeting the Inclusion Criteria for the trial. Please note that persons skilled in the art will appreciated that other sample sizes are possible and within the scope of the present invention.

In this embodiment, the control therapies are generally divided into control treatments by at least two groups. However, a person skilled in the art may appreciate that more control therapies could be used to increase the definition of the therapies.

The main purpose of the preferred embodiment is to conduct a randomized trial to evaluate the clinical efficacy, clinical safety and product reliability of an IMD called “VENTRASSIST® LVAD” in providing long-term circulatory support for patients who have Stage D (or Stage TV) heart failure symptoms. Patients will be randomized either to the “VENTRASSIST® LVAD” or to standard therapy (including any FDA-approved medical or device-based therapy, at the discretion of the treating physician and patient).

Heart failure and disease has been classified by the following definitions. The New York Heart Association (‘NYHA’) functional classification is a commonly used way to gauge the progression of Congestive Heart Failure (‘CHF’) in a particular patient. This classification is used to determine how much CHF limits their lifestyle, and does not apply to a particular de-compensated episode. Depending on symptoms, patients may move in either direction on the NYHA scale.
Class I: No symptoms at any level of exertion.
Class II: Symptoms with heavy exertion.
Class III. Symptoms with light exertion.
Class IV: Symptoms with no exertion.

Heart failure stages from the joint guidelines published by the American College of Cardiology (‘ACC’) and the American Heart Association (‘AHA’) represent a newer classification that complements the NYHA classification.
Stage A: At risk for developing heart failure without evidence of cardiac dysfunction.
Stage B: Evidence of cardiac dysfunction without symptoms.
Stage C: Evidence of cardiac dysfunction with symptoms.
Stage D: Symptoms of heart failure despite maximal therapy.

An important feature of the staging classification is that with the normal natural history of heart failure, patients can only progress in one direction: from Stage A to D. This is meant to reflect the progressive nature of heart failure. Certain drugs or device therapy may arrest the progress of heart failure, or even reverse the effects of heart failure to a certain extent.

The rationale for the design of the preferred embodiment, and the selection of the control group, is as follows. The prior art REMATCH trial demonstrated a survival benefit for the HMI over optimal medical management, but also a significantly higher rate of serious adverse events in the LVAD group. In 2002, these results led to FDA approval of LVAD destination therapy for Stage D heart failure patients ineligible for cardiac transplantation. A year later, the US Centers for Medicare and Medicaid (‘CMS’) approved this therapy for reimbursement, and subsequently the ACC/AHA guidelines add LVAD therapy to the spectrum of therapies for treating patients with advanced heart failure. However, there are substantial variations in treatment practices, which probably reflect variations in preferences regarding the trade-offs between benefits and risks. Since late 2003, only some two hundred and fifty (of the tens of thousands of potential) patients in the US were treated with the HMI for destination therapy, and, by far, the majority of patients received optimal medical management.

### OBJECTIVES AND BACKGROUND

The overall objective of the following described clinical trial 10 of the preferred embodiment is to evaluate the effectiveness and safety of the “VENTRASSIST® LVAD” in providing long-term circulatory support for patients who have chronic Stage D heart failure symptoms (≧60 days) and are ineligible for cardiac transplantation. Currently, patients with Stage D heart failure are treated with a spectrum of therapies, including specialized medical management as well as mechanical circulatory support with an LVAD approved by FDA for destination therapy. The approval by the FDA of LVAD therapy for this indication was based on the REMATCH trial, which demonstrated a significant survival and quality of life benefit of the HMI over optimal medical management. In fact, Kaplan-Meier survival analysis showed a 48% reduction in the hazard of all cause mortality in the LVAD group (hazard ratio=0.52; 0.34-0.78; p=0.001). However, these benefits came at a price: the LVAD group experienced more than twice the rate of serious adverse events, such as infections, bleeding and neurological events, than the medically managed group. Moreover, patients implanted with the HMI had a 65% two-year probability of device replacement.

This profile of adverse events, and variations in practitioner and patient preferences regarding the trade-offs in risks and benefits, is probably one major reason why the adoption of LVAD therapy for this indication has been limited since FDA approval in 2002 and CMS approval the following year. Another reason for limited use is that physicians only have the one small (n=129), although rigorously conducted, randomized trial (i.e., the REMATCH trial) on which to base their clinical decisions regarding the use of VAD destination therapy. Moreover, since the REMATCH trial, medical management for advanced heart failure has evolved to include the use of beta blockers, aldosterone antagonists, and cardiac resynchronization therapy—raising questions about whether the observed outcomes in the medical arm remain relevant to today's heart failure patients.

These factors are reflected in the fact that, since 2003, less than 300 (of the tens of thousands of potential) patients in the U.S. were treated with the HMI for destination therapy. The majority of Stage D patients nowadays are treated with pharmacological therapy, implanted cardioverter defibrillators and cardiac resynchronization therapy (i.e., biventricular pacing), without the use of LVAD therapy. The use of LVADs, and the timing of their implantation, as argued, depends heavily on clinical factors, as well as the risk-benefit perceptions of both the practitioner and the patient. The way in which heart failure patients are currently managed argues for evaluating a novel LVAD against both medical management strategies and the predicate LVAD. To accommodate the various strategies for the clinical management of chronic Stage D heart failure, this protocol defines a randomized trial that includes two modules. These modules are:

Module A (marked in FIG. 1 as item 2): Patients will be randomly assigned to either the “VENTRASSIST® LVAD” or to continued Medical Management Group (‘MMG’), which include, at the discretion of the treating physician and patient, any medical therapy considered optimal standard care, with the option of subsequent implantation of an FDA-approved LVAD.

Module B (marked in FIG. 1 as item 3): Patients, who require “immediate” (within 14 days of enrollment) LVAD support, will be randomly assigned to either the “VENTRASSIST® LVAD” or an FDA-approved LVAD for the DT population.

### Specific Aims

### Primary Endpoint

The primary endpoint for Module A 2 is survival without a disabling stroke (defined as a score of 4 or more on the Modified Rankin Scale). The superiority of the experimental versus control arm will be assessed using an intention-to-treat Log Rank test.

The primary endpoint for Module B 3 is also a composite endpoint of disabling stroke-free (Modified Rankin≧4) survival. The non-inferiority of the experimental device compared to the predicate device will be assessed using a confidence interval approach for the hazard ratio of the composite endpoint.

### Secondary Endpoints

The secondary endpoints are the same for both modules 2 & 3. The following endpoints will be compared between the “VENTRASSIST® LVAD” implanted groups and the respective control groups at the specified time points:

### Survival

All-cause mortality

### Safety

Incidence of serious adverse events

### Functional Status and Hospitalizations

VO₂ max (assessed by a cardiopulmonary stress test)
New York Heart Association (NYHA) Class
Total number of days alive out-of-hospital (as % of total survival)
Incidence of cardiac transplantation

### Quality of Life & Neurocognition

Health-related quality of life
Neurocognition
Neurological functional status (as defined by the Modified Rankin Scale).

### Study Design

This is a prospective, multi-center, randomized, controlled clinical trial 10, comprised of two independent modules 2 & 3. Patients in both experimental modules may be randomized in a 2:1 ratio to receive either the “VENTRASSIST® LVAD” group 4 & 6 or the control therapy 5 & 7. In Module A 2, approximately 180 patients will be randomized, and in Module B 3, approximately 45 patients will be randomized, although the intent is to continue to randomize patients into Module B 3 until enrollment into Module A 2 is completed.

### Randomization

Randomization is controlled centrally. The treatment assignment is sent to the site coordinator electronically, in a secure fashion, and electronic verification of the treatment assignment will be required before proceeding with the treatment intervention. From that point on, primary efficacy is analyzed by intention-to-treat; that is, the patients will be grouped by their assignment at randomization whether or not they actually received the treatment to which they were assigned. Patients are assigned to the appropriate experimental module based on the clinical judgment of the site co-Principal Investigators (surgeon and cardiologist) with regard to the urgency of the need for LVAD implantation.

Module A 2 patients are randomly assigned to receive either the “VENTRASSIST® LVAD” 6 or medical management strategies 7 in a 2:1 ratio. In Module A 2, the surgical implant procedure for the “VENTRASSIST® LVAD” must begin within 48 hours following randomization.

Module B 3 patients are randomly assigned to receive either the “VENTRASSIST® LVAD” 4 or an FDA-approved LVAD 5 for DT indication (e.g., HMI) in a 2:1 ratio. In Module B 3, the surgical implant procedure for both LVADs must begin within 48 hours following randomization.

Separate randomization schemes will be created for each Module 2 or 3. The randomization is stratified by center and blocked to maintain balance over time.

### Study Population

### Characterization of Patient Population

The population of patients in Modules A 2 and B 3 may consist of those with end stage CHF who are not candidates for cardiac transplantation at the time of randomization into the trial. In addition, they will have no concomitant disease at the time of randomization that would limit their survival to less than two years. Patients randomized into this trial may not participate in another investigational intervention study during the course of their participation in this trial.

### Allocation to Module A or B

If the patient has a clinical indication for “immediate” implantation of an LVAD, defined as implantation within 14 days following enrollment, then the patient is allocated to Module B.

Beyond this specific inclusion criterion, all patients who meet the following eligibility criteria qualify for Modules A and B regardless of gender, race, or ethnicity.

### Inclusion and Exclusion Criteria

The Inclusion and Exclusion Criteria are typical of those for a clinical trial of a left ventricular assist device, as will be appreciated by one skilled in the art.

### Treatment Interventions

### Module A-2

Patients will be randomized in a 2:1 ratio to:

### VentrAssist Group—6

Patients randomized to the “VENTRASSIST® LVAD” Group 6 will have the VentrAssist device implanted within 48 hours after randomization.

### Medical Management Group-7

Patients randomized to the MMG 7 continue to receive optimal clinical care for their advanced heart failure. All MMG 7 patients are followed by a specialized heart failure cardiologist, and the timing of all scheduled protocol-related follow-up visits is identical to those of the experimental group. MMG 7 treatment strategies include all device interventions and medical therapy approved by FDA for the treatment of advanced heart failure. At the time randomization patients are required to have received standard of care medical therapy as defined by AHA/ACC Guidelines. During the trial patients continue to receive optimal medical therapy, as tolerated, including but not limited to, angiotensin antagonists (Angiotensin Converting Enzyme inhibitors and Angiotensin Receptor Blockers), beta blockers, aldosterone antagonists, implanted cardioverter defibrillators and biventricular pacemakers.

In accordance with medical management strategies for patients with Stage D heart failure, patients assigned to MMG 7 can be implanted with an LVAD approved by the FDA for Destination Therapy at any time following randomization, at discretion of the physician and the patient. As such, this strategy permits utilization of all approved therapies for Stage D heart failure. The choice of specific therapies, and their timing, is at the discretion of the treating heart failure specialist. (FIG. 1) In keeping with the intent of the trial, elective LVAD implantation for patients randomized to MMG should be no sooner than 6 weeks following randomization, unless the patient de-compensates despite maximal therapy, and the need for implantation becomes more urgent. Clinical de-compensation may manifest by hemodynamic deterioration (e.g., symptomatic hypotension), worsening end-organ function, or clinical indication for increasing inotropic support.

### Module B-3

Patients are randomized in a 2:1 ratio to:

### VentrAssist Group-4

Patients randomized to the “VENTRASSIST® LVAD” Group 4 have the VentrAssist device implanted within 48 hours after randomization.

### Predicate LVAD Group-5

Patients randomized to the Predicate LVAD Group have an FDA-approved LVAD for the Destination Therapy indication (e.g., HMI) implanted within 48 hours after randomization.

### Other Treatment

All patients receive standard medical management for their heart failure and other co-morbid conditions in accordance with current medical practice. This includes standard rehabilitation such as physiotherapy, nutrition, counseling as required and social support.

### Definitions and Measurement of Endpoints

### Primary Endpoint

The primary endpoint for Module A 2 is survival without a disabling stroke (defined as a score of 4 or more on the Modified Rankin Scale). The primary null hypothesis is that there is no difference in the risk of disabling stroke (modified Rankin Score of 4 or 5) or death from any cause between patients randomized to receive the “VENTRASSIST® LVAD” 6 and those randomized to the control group 7. The alternative hypothesis is that the risk of disabling stroke or death from any cause in the “VENTRASSIST® LVAD” arm is greater than the control group. The trial has 80% power to detect at least a 46% reduction (hazard ratio of 0.54) in the risk of disabling stroke or death from any cause randomized to receive the “VENTRASSIST® LVAD” 6 compared to patients in the control group 7.

The primary endpoint for Module B 3 is also survival without a disabling stroke (defined as a score of 4 or more on the Modified Rankin Scale). The primary null hypothesis is that the risk of a disabling stroke or death from any cause in the VentrAssist group 4 will be inferior (i.e. greater) to the control group. The alternative hypothesis is that the risk of patients experiencing a disabling stroke or death from any cause in the VentrAssist group 4 will be non-inferior to the control group 5 (i.e., no worse). The plan is to have both Modules enroll during the same time period. In the time expected to complete enrollment for Module A, we expect to accrue around 45 patients in Module B. The primary analysis then will assess the non-inferiority of the risk of an event in patients with the “VENTRASSIST® LVAD” 4 compared to the control group 5 by constructing a confidence interval for the hazard ratio of disabling stroke or death for the control group 5 versus the “VENTRASSIST® LVAD” group 4.

However, there is no limitation to enrollment in Module B 3, and if patients accrue into Module B 3 at much greater numbers than expected, then this will create the opportunity to perform formal hypothesis testing.

### Secondary Endpoints

The secondary endpoints are the same for both modules 2 & 3. The following will be compared between the “VENTRASSIST® LVAD” implanted groups and the respective control groups as follows:

### Survival

All-cause mortality

### Functional Status and Hospitalizations

### NYHA & VO₂ Max

Functional status, as assessed by NYHA Classification and VO₂ max, will be evaluated and compared between the “VENTRASSIST® LVAD” groups and the control groups.

### Days Alive and Out of Hospital

The total number of days alive and out-of-hospital (as a % of total survival) will be compared between the “VENTRASSIST® LVAD” groups and the control groups.

### Cardiac Transplantation

The number of patients who undergo cardiac transplantation over the course of the trial, despite ineligibility for transplant at the time of randomization, will be compared between the “VENTRASSIST® LVAD” groups and the control groups.

### Quality of Life

Quality of life will be compared between the “VENTRASSIST® LVAD” groups and the control groups, assessed by standard tools for assessing quality of life as will be appreciated by one skilled in the art

### Neurocognition

Neurocognition will be compared between the “VENTRASSIST® LVAD” and control groups using a standard battery of tests.

### Neurological Functional Status

Neurological functional status will be assessed by the modified Rankin Scale, focusing exclusively on functional loss related to neurological disease.

### Clinical Safety

The definitions of Adverse Events (AEs), Serious Adverse Events (SAEs), Unanticipated Serious Adverse Events (USAEs), and Device Relatedness will be typical of trials of an LVAD, and will be well appreciated by one skilled in the art.

### Adverse Events

The incidence of serious adverse effects over the course of the trial will be compared between the “VENTRASSIST® LVAD” groups and respective control groups. The endpoints for safety will be reported as the frequencies of occurrence of each adverse event, the rate of adverse events per patient/year and time to each event. In addition, the number of patients with each serious adverse event type will be recorded.

Safety data will be collected throughout this study and the incidence of each event type will be computed along with the 95% confidence intervals.

### Serious Adverse Event

A serious adverse event is one that results in a fatality; is life-threatening; results in permanent disability; requires hospitalization or prolongs a hospital stay.

### Unanticipated Serious Adverse Event

An unanticipated serious adverse event is any serious adverse event that is not protocol-defined, documented in the Instructions for Use or the patient consent form.

### Device Relatedness

Device relatedness will be classified, according to the judgment of the site principal investigator.

### Analytical Plan

### Efficacy

### Module A-2

### Analytic Plan

The primary analysis assesses the superiority of the “VENTRASSIST® LVAD” 6 to the Medical Management Group (MMG) 7 with respect to the composite endpoint of disabling stroke (defined as a Modified Rankin Score of 4 or 5) or death from any cause. The primary null hypothesis is that there is no difference in the risk (i.e. hazard) of disabling stroke or death from any cause between patients randomized to receive the “VENTRASSIST® LVAD” 6 and those randomized to MMG 7. The trial is powered against an alternative hypothesis that there is a 46% reduction (hazard ratio of 0.54) in the risk of the composite endpoint for patients randomized to receive the “VENTRASSIST® LVAD” 6 compared to patients receiving MMG 7. The null and alternative study hypotheses are therefore,

H₀:θ=1 versus H₁:θ≠1,

where θ represents the hazard ratio for the composite endpoint for patients randomized to receive the “VENTRASSIST® LVAD” 6 compared to patients receiving MMG 7.

The primary null hypothesis is tested in an intent-to-treat analysis using the log-rank statistic to test for a difference in the disabling stroke-free survival distributions between randomization arms. Module A 2 will be an event driven trial with follow-up continuing until the 103^{rd} event is observed. One hundred and three events are required to ensure at least 80% power (power is approximately 82.5%) to test this null hypothesis against this alternative hypothesis using a two-tailed 0.05 level test. This number of events takes account of a single interim analysis to be executed after approximately 75% of the expected number of events are observed (i.e., after seventy-eight events).

The alternative hypothesis in Module A is based on assumptions about the composition of the control group, rates of mortality and disabling stroke. It is assumed that approximately one-third of control patients will eventually receive an LVAD, while the remaining two-thirds will not. The assumed disabling stroke-free survival for patients treated with MMG who do not receive an LVAD is 30% at two years, which is based on the REMATCH results and studies with advanced heart failure patients during the beta blocker era (2, 5, 6, 7). For those MMG patients who receive an LVAD, we assumed a 40% two-year disabling stroke-free survival.

Based on these assumptions, the expected two-year event rate for Module A control patients is set to be 67%. The assumed two-year event rate for patients treated with the “VENTRASSIST® LVAD” is 45%. These assumed event rates correspond to a hazard ratio of 0.54 for the risk of an event for patients treated with the “VENTRASSIST® LVAD” compared to patients treated with MMG.

### Assessing the Proportional Hazards Assumption

The validity of the log-rank test of the equality of event-free survival depends on the appropriateness of the proportional hazards assumption. This assumption is assessed both graphically and by a formal statistical test. Graphical assessments will be based on two plots: (1) a “log-negative-log plot”, i.e., a plot of log(−log(S(t)) versus log(t) for each treatment group and (2) a plot of the “scaled Schoenfeld residuals” versus log t for each treatment group (where by “log” we mean the natural logarithm and by “t” we mean time in months). A formal test for the appropriateness of the proportional hazards assumption is performed if there is strong evidence of non-proportional hazards that could bias the result of the test of the null hypothesis (e.g., the survival curves cross). Note that concern about crossing hazards as might be expected if there were an early benefit to MMG and a later benefit to LVAD therapy is taken into account. There is no deviation from the proposed log-rank analysis if the non-proportionality stems from diverging hazards resulting from a monotonic accelerated benefit (or deficit) for one arm compared to the other.

The formal test assesses the significance of the interaction between the indicator for treatment group and log(t) in a Cox proportional hazards regression model that also includes a main effect for the randomization group. Statistical significance of the interaction term (based on a two-tailed 0.05 level test) would indicate a violation of the proportional hazards assumption. In that cases a comparison of 2-year survival estimates based on a Kaplan-Meier analysis would be more appropriate. Therefore, if the proportional hazards assumption is not valid due to crossing survival functions, the primary null hypothesis is tested using a confidence interval approach based on the log−log survival function, as suggested by Kalbfleisch and Prentice.

### Sample Size

The sample size is determined based on the following assumptions: time-to-event is exponentially distributed with a constant hazard the two-year event rate for patients randomized to MMG is 67% (see above justification) patient accrual will occur uniformly for 24 months and follow-up will continue for an additional 18 months after the last patient is randomized. (Note: that all patients will be followed for 2 years for all endpoints; and for an additional 3 years for survival and device reliability). A total of 180 patients, randomized in a 2:1 allocation to the “VENTRASSIST® LVAD” or to MMG, will yield the required 103 events within the assumed accrual and follow-up periods and assure at least 80% power (power will be approximately 82.5%) to detect a 46% reduction (hazard ratio of 0.54) in the risk of an event for the “VENTRASSIST® LVAD” arm compared to MMG. This reduction in risk corresponds to an absolute reduction in the 2-year event rate of 22% for the “VENTRASSIST® LVAD” from 67% to 45%. (Note that 180 patients is approximately 10 more than the strict minimum required under these assumptions. An additional 10 patients will be randomized to help ensure study completion within 42 months).

### Module B

### Analytic Plan

The primary aim of Module B is to obtain an estimate of the relative benefit of the “VENTRASSIST® LVAD” to the control LVAD. The relative benefit is estimated based on a 95% confidence interval for the hazard ratio for the composite endpoint (disabling stroke or death from any cause) for patients randomized to the “VENTRASSIST® LVAD” compared to the control LVAD. An expected sample size of 45 patients is randomized in a 2:1 allocation to the “VENTRASSIST® LVAD” or to the control LVAD. The expected sample size is not based on standard statistical criteria, rather it reflects the maximum number of patients expected to be eligible for randomization into Module B in the time required to complete patient accrual into Module A.

However, accrual in Module B is not capped at 45 patients, and if patients accrue into Module B at much greater numbers than expected, then this creates the opportunity to perform formal hypothesis testing (i.e., we would conduct formal analyses after 106 events were observed). In that case, the primary null hypothesis is that the treatment with the “VENTRASSIST® LVAD” will be inferior to treatment with the control LVAD. The alternative hypothesis is treatment with the “VENTRASSIST® LVAD” will be non-inferior to treatment with the control LVAD.

The “VENTRASSIST® LVAD” will be deemed non-inferior to the control LVAD, if the hazard ratio (θ) for disabling stroke or death from any cause is shown with high probability to be greater than 0.80 for patients treated with the control LVAD compared to patients treated with the “VENTRASSIST® LVAD”. The study hypothesis null and alternative hypotheses are

H₀:θ<0.80 versus H₁:≧0.80.

This choice of non-inferiority margin represents the largest practical value consistent with a valid randomized trial of an experimental device against an active control device

### Sample Size

The non-inferiority design follows the approach outlined by Blackwelder. We have adapted his technique for assessing non-inferiority to survival data, following the method described by Fleming.

The sample size is based on the assumption that event times are exponentially distributed with a constant hazard. Sample size is calculated to ensure 80% power to reject the null hypothesis of non-inferiority at the 0.05 level (with a one-side test). It is anticipated that the two-year event rate is 45% with the “VENTRASSIST® LVAD”, and 55% with the control LVAD. As in Module A, we assume that patient accrual will require 24 months and plan for an additional 18 months of follow-up after the last patient is randomized. One-hundred and six (106) events provide approximately 80% power to detect that the hazard ratio (θ) for event from any cause is at least 0.80 based on a one-sided 0.05 level log-rank test. Under the stated assumptions for patient accrual and plan for additional follow-up, 192 randomized patients would be expected to yield 106 events within the total study duration of 42 months.

The sample size (n) of 192 was obtained by dividing the calculated number of events (e=106) by an estimate of the probability of an event over the duration of the study

$$( i . e . n = \frac{e}{P ( event )} ) .$$

The probability of an event was estimated using the formula presented in D. Collett (10),

$$P ( event ) = 1 - \frac{1}{6} ( \overline{S} ( f ) + 4 ( \overline{S} ( 0.5 a + f ) ) + \overline{S} ( a + f ) ) .$$

In this formula a is the accrual period of the study (i.e. 24 months), f is the additional follow-up period after accrual is completed (i.e. 18 months) and S̅(t) is the average value of the survival function at time t (the weighted average of the survival functions of each treatment group). Under the assumed event rates the probability of on event over the duration of the study is 0.553. Thus, the sample size required to obtain 106 events with a 24 month accrual period and 18 months of additional follow-up is 106/0.553≅192.

### Non-Inferiority Margin

The choice of non-inferiority margin must reflect clinical judgment and the effectiveness of the control device. A single randomized study comparing the HMI to optimal medical management in 129 patients estimated its effect in terms of reduction in all-cause mortality to be 48%. That is, the hazard ratio was estimated to be 0.52 with an associated 95% confidence interval of (0.34, 0.78). The inventors contend that a non-inferiority margin of 0.20 is the smallest practical margin for the proposed analysis of Module B, given the design emphasis on Module A, the likely low enrollment into Module B, and the maintenance of a large proportion (more than one-half) of the estimated control device compared to medical management.

### Analysis of Primary Endpoint

Cox proportional hazards regression is used to obtain an estimate of the (natural) log of the hazard ratio, log(\hat{θ}), and its asymptotic standard error, se(log(\hat{θ}). The lower bound to assess non-inferiority will be computed as exp{log(\hat{θ})−1.645 se(log(\hat{θ})}, where exp(x)=e^{x}. The Cox model contains a single indicator for randomization group (or treatment group). The log hazard is estimated as the maximum partial likelihood estimator. The variance (squared standard error) of the estimate is based on the inverse information matrix evaluated at the estimated log hazard ratio. The primary analysis is both by intention-to-treat, including all patients as randomized regardless of whether they received the randomized treatment; and considering patients as treated is also performed. Non-inferiority is only claimed if both the intention to treat analysis and the “as treated” analysis reject H₀.

If the null hypothesis of inferiority is rejected, a subsequent test of superiority is performed. That is, a test of H₀: θ=1 versus H₁: θ≠1 will be performed. This test is based on a two-sided 0.05 level log-rank test.

### Assessing the Proportional Hazards Assumption

The assumption of proportional hazards is assessed as for Module A. If the assumption of proportionality does not hold due to crossing hazards, a comparison is performed of the two-year event rates using the same method as that outlined for Module A. When this approach is used, a non-inferiority margin of 0.08 (corresponding to the non-inferiority margin of 0.20 for the planned analysis based on the hazard ratio) is used. The null and alternative hypotheses is defined by:

H_{0:}π₁−π₀0>0.08 versus H_{1:}π₁−π₀≦0.08,

where π₀ and π₁ are the true two-year event rates for patients randomized to the control LVAD and “VENTRASSIST® LVAD” respectively.

### Analyses of Secondary Endpoints

The secondary analyses performed for Module B is the same as those described for Module A.

### Clinical Safety

Information about the clinical safety of the “VENTRASSIST® LVAD” is presented for each Module separately in terms of the rate of occurrence of each adverse event per patient month of support and associated confidence intervals. Patient information across modules is also combined by a meta-analytic approach with confidence intervals presented using both a fixed effects and a random effects approach.

In order to better characterize the clinical safety of the “VENTRASSIST® LVAD”, data from other clinical trials of the “VENTRASSIST® LVAD” is pooled with the clinical safety data collected from the trial which is the subject of this embodiment. Pooling is best justified when the other clinical trials use the same definitions of AEs, SAEs, and USAEs, and the inclusion and exclusion criteria are substantially the same. That is, pooling is best justified when the patient populations are identical. If the definitions or the patient populations are different, then the data may not be pooled statistically, but the data may still be used in a descriptive manner.

### Engineering Reliability

In order to better characterize the engineering reliability of the “VENTRASSIST® LVAD”, additional device reliability data from other “VENTRASSIST® LVAD” experience is combined with the data collected from the trial which is the subject of this invention. Reliability data is summarized as rates per patient month of follow-up and combined using a meta-analytic approach with confidence interval estimates based on a random effects model.

Additionally, the data forming the control group may be derived from the results of several control therapies. The results of the control therapies may be obtained from clinical result of publicly available documentation to provide a pool of control data for analysis and comparison to the experimental group.

Although the invention has been described with reference to particular examples and embodiments, it will be appreciated by those skilled in the art that the invention may be embodied in many other forms without departing from the scope and spirit of the invention as defined in the following claims.

In the claims which follow and in the preceding description of the food preparation mould, except where the context requires otherwise due to express language or necessary implication, the word “comprise” or variations such as “comprises” or comprising is used in an inclusive sense, i.e. to specify the presence of the stated features but not to preclude the presence or addition of further features in various embodiments of the mould.

Any reference to prior art information herein is not to be taken as an admission that the or part of the prior art information forms part of the common general knowledge in Australia or elsewhere.

What is claimed is:

1. A method of conducting a randomized controlled clinical trial, the method comprising the steps of:
trialing, with respect to a first group of patients as an experimental group, an experimental treatment; and
trialing, with respect to a second group of patients as a control group, at least first and second control therapies,
wherein said control therapies have been previously validated or are a known standard of care.

2. The method of claim 1, wherein said control therapies have been previously validated in respect of safety, efficacy and effectiveness.

3. The method of claim 2, wherein said experimental therapy includes the use of a medical device.

4. The method of claim 3, wherein the medical device is a left ventricle assist device.

5. The method of claim 3, wherein at least one of said at least first and second control therapies includes a pharmaceutical therapy.

6. The method of claim 5, wherein at least one of said at least first and second control therapies includes the use of a second medical device.

7. A method of assessing the results of a randomized controlled clinical trial, the method comprising the step of:
comparing data relating to clinical efficacy, clinical safety and reliability obtained from trialing a therapy with respect to an experimental group with data relating to clinical efficacy, clinical safety and reliability from trialing at least first and second control therapies with respect to a control group,
wherein data from at least the first control therapy is compiled from data obtained from publicly available research material.

8. The method of claim 7, wherein said first control therapy is similar to the therapy trialed with respect to the experimental group but sufficiently different to warrant the conduct of a clinical trial.

9. The method of claim 8, wherein said experimental group therapy comprises the use of a medical device.

10. The method of claim 9, wherein said first control therapy includes the use of a second medical device.

11. The method of claim 10, wherein said second control therapy comprises a pharmaceutical therapy.

12. A method of conducting a randomized controlled clinical trial, the method comprising the steps of:
trialing, with respect to a first group of patients as an experimental group, an experimental therapy using a first left ventricle assist device (LVAD); and
trialing, with respect to a second group of patients as a control group, at least first and second control therapies,
wherein said at least first and second control therapies have been previously validated or are a known standard of care and said first control therapy includes the use of a second LVAD.

13. The method of claim 12, wherein said second control therapy comprises a pharmaceutical therapy.

14. A method of conducting a prospectively randomized controlled clinical trial comprising the step of:
comparing data relating to clinical efficacy, clinical safety and reliability from trailing a therapy with respect to an experimental group with data relating to clinical efficacy, clinical safety and reliability from trialing at least first and second control therapies with respect to a control group,
wherein the control group includes data from the at least first and second control therapies and wherein the reliability data from the experimental therapy is pooled with reliability data from clinical experience of the experimental therapy in populations of patients outside the clinical trial.

15. A method of assessing the results of a randomized controlled clinical trial of an implantable medical device (IMD), the method comprising the steps of:
determining clinical efficacy of an experimental IMD by comparing experimental IMD data with corresponding data of at least one control therapy;
determining clinical safety of the experimental IMD by conducting an absolute number comparison of experimental IMD results data with corresponding results data of at least one control therapy wherein all patients are participating within said clinical trial or another comparable clinical trial;
determining product reliability of the experimental IMD by comparing an absolute number of failing experimental IMDs with the total number of patients using the experimental therapy; and
assessing the results of the clinical trial by comparing the determined clinical efficiency, clinical safety and product reliability.

16. The method of claim 15, wherein the sample size to determine clinical safety is larger than the sample size to determine clinical efficacy.

17. The method of claim 16, wherein the results of the control therapy to determine clinical safety are derived from pooled data of at least two different clinical trials.

18. The method of claim 17, wherein the sample size to determine product reliability is larger than the sample size to determine clinical safety.

19. The method of claim 18, wherein the results for the control therapy used to determine product reliability are derived from pooled data including data relating to patients not participating within the or any clinical trials.
